(19) United States
(12) Patent Application Publication
(10) Pub. No.: US 2005/0197768 A1
(43) Pub. Date: Sep. 8, 2005

(54) Adjustment of the operation of an application based on a geographically varying parameter value

(75) Inventors: Terho Kaikuranta, Piispanristi (FI); Jakke Makela, Turku (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/794,412

(22) Filed: Mar. 4, 2004

(51) Int. Cl. G01C 21/26

(52) U.S. Cl. 701/213; 701/201; 701/216

(57) ABSTRACT

The invention relates to a mobile device comprising at least one application and a user interface enabling a user to select a geographical location as input for a further application. In order to enable a particularly user friendly usage of applications which advantageously take account of the variations of a geographically varying parameter value, the mobile device further comprises a processing component adapted to automatically determine for a geographical location selected by a user a geographically varying value of at least one parameter. The at least one application is adapted to use a value of the at least one parameter, determined by the processing component, for adjusting its operation to a geographical location selected by a user as input for the further application. The invention relates equally to a corresponding software program product and a corresponding method for use in such a device.

### FIELD OF THE INVENTION

The invention relates to the adjustment of the operation of at least one application in a mobile device based on a geographically varying parameter value.

### BACKGROUND OF THE INVENTION

A variety of applications are known which are based on parameters having a geographically varying value. One such application, for example, is an application which provides the functions of a compass.

Without special measures, a compass points always in a direction which is similar to the direction of the earth's magnetic field. The direction of the earth's magnetic field, however, often deviates from North as shown in maps, and the amount of the deviation varies geographically. The deviation of the direction of the earth's magnetic field from North thus constitutes a parameter which has a geographically varying value.

At some locations this deviation, which is also referred to as declination, is considerable. It may reach several tens of degrees. Toronto (Canada) is a good example of a location with a particularly large declination. The presence of the declination renders a reliable usage of a compass more complicated than normal users realize. Some users are able to navigate with a north-direction reference, but the effect of the declination is not generally well known in the population.

For illustration, FIG. 1 presents a map of the world. A plurality of curves indicate the respective deviation of the direction of the earth's magnetic field from North in degrees. The curves are labeled for declinations from −60° to +40° in steps of 10°.

When a user travels, the declination may thus change significantly, and the error of a compass used by the user increases accordingly if the declination is not compensated in the compass application. This problem influences all compass users, regardless of whether they are capable of using a compass for navigation purposes or not.

Various approaches are known from the state of the art for compensating the declination.

For example, there exist maps showing the correct declination values and tables listing the correct declination values for various global locations or for various area locations, respectively. Such maps and tables enable a user of a compass application to take account of the declination at a specific location. The declination values may be included for instance in a manual of a mobile device comprising a compass application. The user may then manually enter the declination value selected from the manual for a specific geographical location at which the compass application is to be used.

Such an approach is highly inconvenient for a user, though. For instance, a businessman who is used to navigate in non-familiar locations with support of a compass provided by a mobile phone may travel from London to New York. When landed in New York, the declination is completely different from what it was in London, the compass may point in a wrong direction by about 60°. In order to be able to compensate this error, the businessman has to carry along a phone manual or otherwise know the correct declination value. The manual may often not be there when needed, and a reference direction will often not be available.

There exist as well automated systems, like marine navigation systems, which employ electrical navigation aids (navaids). An electrical navigation aid may use declination data stored in an electronic map and automatically correct magnetic heading data. An example of such an electrical navigation aid is the Raytheon RayChart 620 chart plotter, which uses C-MAP charts in combination with a magnetic heading sensor. This approach has the disadvantage, however, that a device which does not have access to an electronic map including declination data is not able to correct magnetic heading data accordingly.

Further, some GPS (Global Positioning System) receivers comprising a compass application have built-in declination correction tables or declination correction algorithms that can be used by the receiver for correcting the current declination when the location of the receiver has been determined based on GPS signals. Still, not every mobile device has an integrated GPS receiver.

Moreover, it has been proposed that base stations of a mobile communication network could provide declination information to mobile terminals. This approach, which has not been implemented so far, has the disadvantage that it requires standardization and network functionality development, which are both rather slow and expensive processes. In addition, this approach can only be used for those mobile devices which are able to communicate with the respective mobile communication network.

Even though the problems of compass applications in mobile devices due to the declination have been identified a long time ago, a satisfying solution has not been presented so far.

While the above described problems relate to the geographically varying declination value, similar problems may obviously occur with any other geographically varying parameter value.

### SUMMARY OF THE INVENTION

It is an object of the invention to enable a particularly user friendly usage of applications which advantageously take account of the variations of a geographically varying parameter value.

A mobile device is proposed which comprises at least one application and a user interface enabling a user to select a geographical location as input for a further application. The proposed mobile device further comprises a processing component adapted to automatically determine for a geographical location selected by a user via the user interface a geographically varying value of at least one parameter. The at least one application is adapted to use a value of the at least one parameter, determined by the processing component, for adjusting its operation to a geographical location selected by a user via the user interface as input for the further application.

Moreover, a software program product is proposed, in which a software code for supplying at least one application in a mobile device with a geographically varying parameter value is stored. When running in a processing component of a mobile device, the software code realizes the step of receiving information on a geographical location selected by a user via a user interface as input for a further application. Further, the software code realizes the step of determining for the selected geographical location a value for a geographically varying value of at least one parameter. Further, the software code realizes the step of providing the determined value of the at least one parameter to the at least one application in order to enable the application to adjust its operation to the selected geographical location.

Finally, a method of adjusting the operation of at least one application in a mobile device based on a geographically varying parameter value is proposed. The proposed method comprises receiving information on a geographical location selected by a user via a user interface of the mobile device as input for a further application. The proposed method further comprises determining for the selected geographical location a geographically varying value of at least one parameter. The proposed method further comprises adjusting the operation of the at least one application to the selected geographical location using the determined value of the at least one parameter.

It is to be noted that the further application can be internal or external to the mobile device.

The invention proceeds from the consideration that for large population consumers, the management of a geographically varying parameter value should be fully transparent and automatic. That is, the management of such a parameter value should require no additional actions or attention from a user.

The invention further proceeds from the consideration that users of a mobile device are familiar with applications which comprise a feature for selecting a specific location. For example, a user usually adjusts the time of a clock of a mobile device when a destination in another time-zone is reached. Some mobile devices have a convenient feature for this time adjustment. Nokia communicators, for example, have an integrated list of geographical locations or destinations that may be selected by a user for an automatic time difference adjustment. Thus, the user does not have to know the respectively required time difference. The same mechanism is sometimes employed in addition for automatically adjusting country and area codes for telephone numbers. There are also some other applications that have a location or city selection function, such as the WorldMate weather service.

It is proposed that a setting feature of a certain application, for instance a clock setting feature of a application controlling the clock of the mobile device, is enhanced in a way that if a geographic location is selected by a user as reference for this certain application, at the same time the geographically varying value of a parameter is determined based on the input geographical location and used for adjusting some other application which relies on this geographically varying parameter value.

It is an advantage of the invention that it ensures a very good usability of an application which should take into account the variations of a geographically varying parameter value. There is no necessity that a user understands or pays attention to the problem of variations in a geographically varying parameter value at all.

It is further an advantage of the invention that its implementation in a mobile device is rather simple. Further, the invention fits in particularly well with mobile devices which already have a corresponding location dependent feature, for example a corresponding time management. Such a location dependent feature may be found in particular in business category devices which are intended for customers who travel a lot, like the mobile terminal Nokia 9210i.

The at least one geographically varying parameter value can be a correction value which enables a direct adjustment of the operation of the at least one application. Alternatively, it can be any other value which allows to obtain such a correction value.

The at least one geographically varying parameter value can further be determined in various ways.

In one embodiment of the invention, a storage component stores a plurality of geographical locations and associated to each geographical location a specific geographically varying parameter value. The locations and values can be stored for example in the form of a table. The processing component can then be adapted to retrieve a list of the stored geographical locations from the storage component and to present this list to a user via the user interface for selecting a specific location. Further, the processing component can be adapted to determine the at least one geographically varying parameter value for a selected geographical location by selecting the corresponding value associated in the storage component to the selected geographical location. It is to be understood that values for the further application, for example values for a time adjustment, can be stored and selected in exactly the same manner. It is an advantage of this approach that very accurate values can be used for each selectable geographical location. The stored data can for example be fixed, be suited to be updated as a whole, or be suited to be supplemented on a location by location basis.

In another embodiment of the invention, only data of a map is stored in a storage component for supporting the determination of the geographically varying parameter value. The processing component can then be adapted to retrieve the data of this map from the storage component and to present a corresponding map to a user via the user interface. Further, the processing component can be adapted to calculate the geographically varying value of the at least one parameter for a geographical location selected by a user by means of a mathematical algorithm. It is to be understood that a value for the further application, for example for a time adjustment, can equally be calculated by means of a mathematical algorithm for a selected geographical location. It is an advantage of this approach that a very accurate positioning of the mobile device is not needed. Further, the requirements on the memory of the mobile device decrease by using an algorithm, since the to be determined values do not have to be stored. Moreover, no update of the stored data is needed if a completely new location is to be defined. Areas where the greatest accuracy of the geographically varying parameter value might be needed are mostly not populated, for instance Antarctica. It might not be reasonable from a commercial point of view to cover these areas as well, for example if the memory requirement is high. In one embodiment of the invention, the possibility of a manual entry of the geographically varying parameter value might therefore be offered in addition, in order to cover such low-populated areas.

The invention can be employed for adjusting the operation of various applications based on any geographically varying parameter value.

In one embodiment of the invention, the at least one application comprises by way of example a compass application, and the geographically varying value of the at least one parameter comprises a declination related value for this compass application, for instance a declination correction value. The location selection is a rather simple task, and it can be used to hide the more difficult task of correcting the declination in a compass application. The users only have to known that the compass functions correctly if they have selected a geographical location close to their actual location.

In another embodiment of the invention, the at least one application comprises by way of example a lightning alerting application. The geographically varying value of the at least one parameter may then be related for instance to the probability of lightning at a respective geographical location. A lightning alerting application might then be switched off automatically in geographical locations in which a very low probability of lightning is given, in order to save power of the mobile device. In case the at least one application comprises a lightning alerting application, the geographically varying value of the at least one parameter may equally be related to a desired lightning detector sensitivity setting for a respective geographical location. If a lightning alerting application in a mobile device identifies a lightning from fast transient peaks in a received RF (radio frequency) signal, the amplitude of the peaks which will result in an alert might be adjusted to the conditions at a respective geographical location with such a lightning detector sensitivity setting.

Also various other applications of a mobile device might benefit of a geographical control of their behavior, for example for minimizing the power consumption of the mobile device.

If the proposed mobile device is a mobile station which is suited to communicate with a mobile communication network, for instance a mobile phone, it may comprise in addition a receiving component for receiving information on the current geographic location of the mobile device from such a mobile communication network via the air interface. The processing component may then determine the geographically varying value of at least one parameter specifically for a geographical location identified by the mobile communication network, if such information is received from the mobile communication network when an updating of the further application and/or the at least one geographically varying parameter value is required. This supplementary approach requires a sufficient field strength at the geographical location of the mobile device, however.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a diagram presenting a map of the world including an indication of declination values;

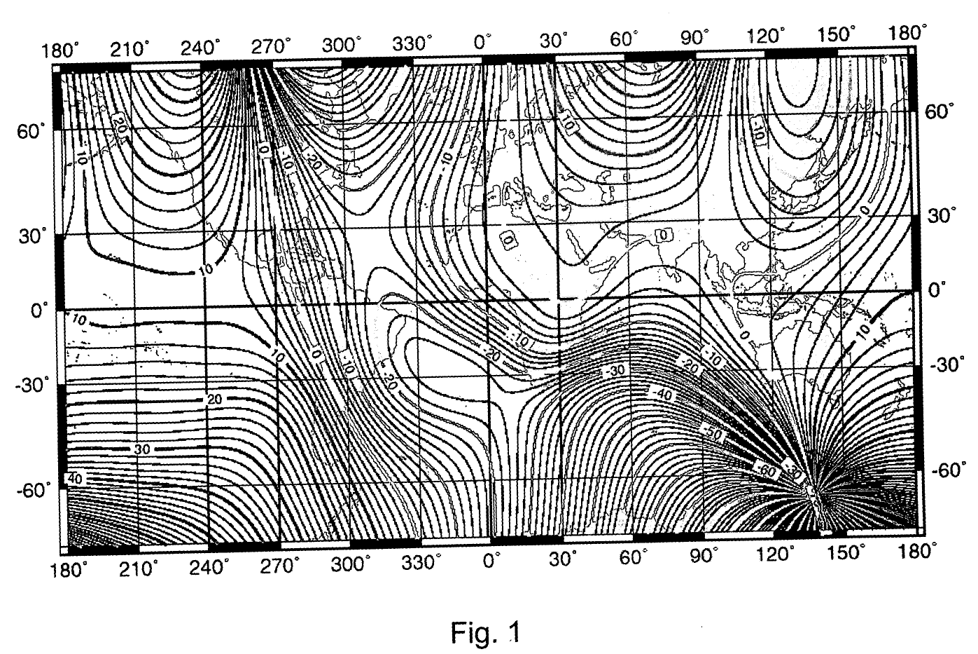

FIG. 2 is a schematic block diagram of a first embodiment of a mobile device according to the invention;

FIG. 3 is a flow chart illustrating the operation in the mobile device of FIG. 2;

FIG. 4 is a presentation of a user interface for use in the mobile device of FIG. 2;

FIG. 5 is a schematic block diagram of a second embodiment of a mobile device according to the invention; and

FIG. 6 is a flow chart illustrating the operation in the mobile device of FIG. 5.

### DETAILED DESCRIPTION OF THE INVENTION

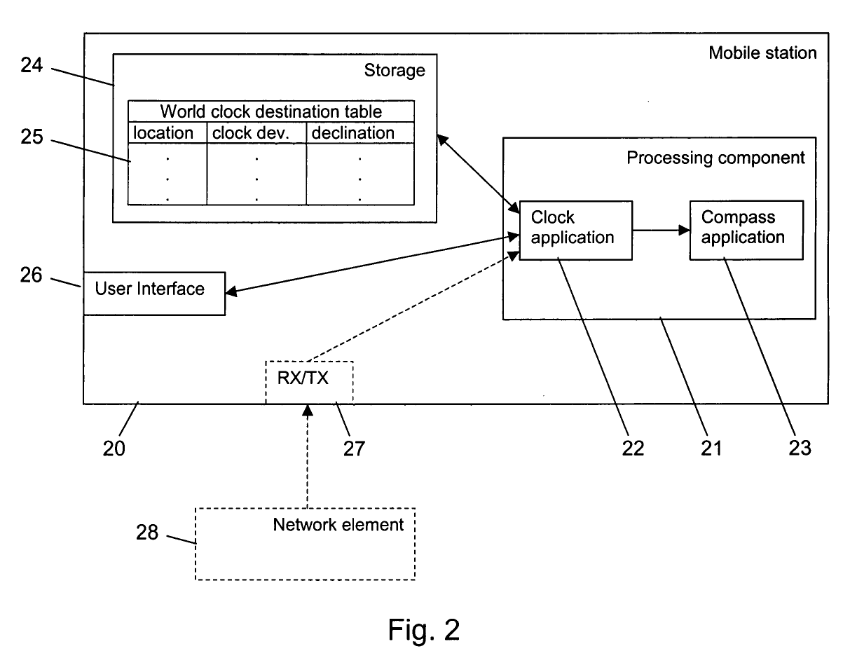

FIG. 2 schematically presents a first mobile station 20 as a first embodiment of a mobile device according to the invention. The mobile station 20 provides a compass function which can be adjusted to the declination at a respective location.

The mobile station 20 comprises a processing component 21, which may run a clock application 22 and a compass application 23. The clock application 22 provides various clock related functions to a user and the compass application 23 provides the compass function to a user.

The clock application 22 has access to a storage component 24, which stores a world clock destination table 25. The world clock destination table 25 includes a first column with an identification of a plurality of locations, a second column with an indication of the clock deviation at a respective location, and a third column with an indication of the declination at a respective location. That is, a specific indication of a clock deviation and a specific indication of a declination are associated to each stored location.

The clock application 22 moreover has access to a user interface 26.

Optionally, the mobile station 20 can be a part of a system which in addition comprises at least a network element 28 of a mobile communication network, for instance a base station. The network element 28 may then support a supplementary adjustment of the compass function of the mobile station 20 in certain situations. In this case, the clock application 22 may further have access to a transceiver RX/TX 27 of the mobile station 20. The network element 28 and the transceiver RX/TX 27 are indicated with dashed lines.

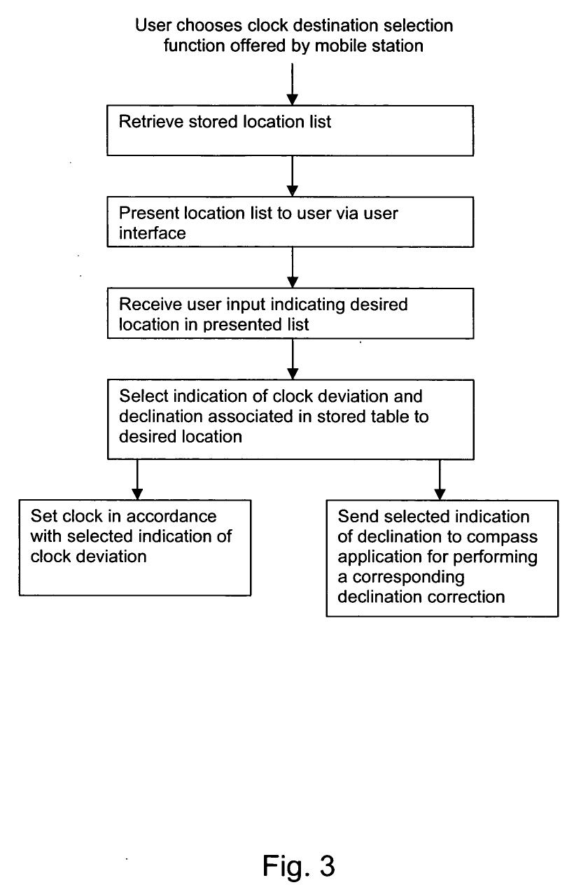

The adjustment of the compass function provided by the compass application 23 of the mobile station 20 of FIG. 2 will now be explained with reference to FIG. 3, which is a flow chart illustrating the operation of the clock application 22 of the mobile station 20 of FIG. 2.

A user who has changed his or her location may choose a clock destination selection function offered by the clock application 22 of the mobile station 20 for updating the clock of the mobile station 20.

Thereupon, the clock application 22 retrieves a list of selectable locations from the storage component 24, more specifically from the first column of the world clock destination table 25.

The clock application 22 then presents the retrieved location list to a user via a display of the user interface 26.

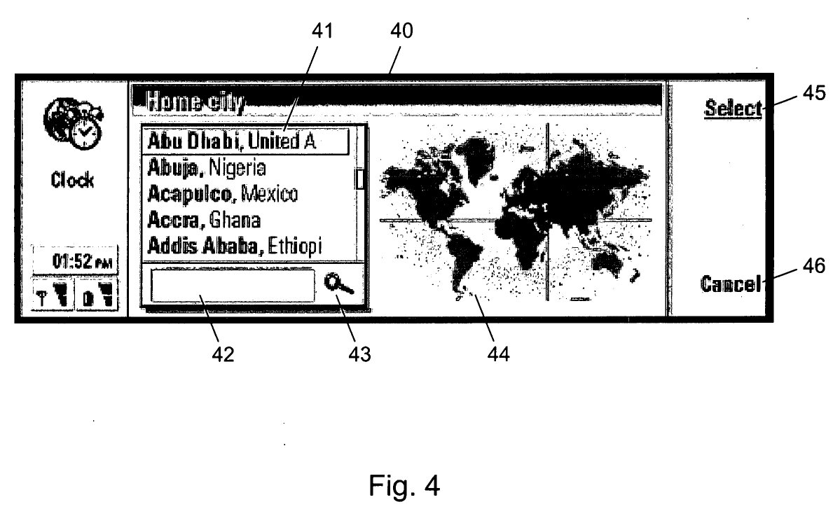

The presentation can be for example identical to the world clock destination selection feature of the Nokia mobile station 9210i. This presentation on a display 40 is shown by way of example in FIG. 4. The presentation includes a respective portion of a list 41 of home cities sorted in an alphabetic order. The displayed portion of the list 41 can be changed by a user by scrolling. Each of the displayed cities can be highlighted by the user. The user may also enter the name or the beginning of the name of a specific city in a search field 42 and then start a search for this city in the list of locations by activating a search function associated to a presented magnifying glass 43. The presented portion of the list 41 will then start with the city of which the name was entered by the user. The presentation includes in addition a map of the world 44, with a reticule indicating the location of the respectively highlighted city.

The user may further select a highlighted city as the desired location by activating a select function associated to a “Select” option 45. Alternatively, the presentation can be left again by activating a cancel function associated to a “Cancel” option 46. In addition, the presentation includes conventional indications provided by a mobile station, like the current time, the status of the battery of the mobile station and the field strength of received RF signals.

In case the user selects one of the presented cities as the desired location, the clock application 22 receives a corresponding indication via the user interface 26.

The clock application 22 thereupon selects the indication of the clock deviation and the indication of the declination which are associated in the world clock destination table 25 in the storage component 24 to the desired location.

Next, the clock application 22 performs a time difference adjustment for setting the clock of the mobile station 20 in accordance with the selected indication of the clock deviation, as known from the state of the art.

In addition, the clock application 22 forwards the selected indication of the declination to the compass application 23, and the compass application 23 performs a declination correction in accordance with the selected indication of the declination. The indication of the declination can be in particular a declination correction value, which can be used directly by the compass application 23 for correcting the declination. The compass application 23 uses this declination correction until a further update of the clock is caused by the user.

A user will often be used to selecting a location for an automatic time difference adjustment without knowing the exact time difference, in particular on long distance trips. In any case, such a selection of a location for adjusting the clock will be considered by a user to be a simple and convenient task. The manual of the presented mobile station may now state that the compass function of the mobile station works properly if the world clock destination or home city is correctly set. Users thus know that the compass functions correctly if they have selected a location close to their actual location. The presented embodiment completely hides the task of adjusting the compass declination with a respective correct value, as it is exploits a normal traveling behavior of a user for performing an automatic adjustment of the declination. In this way, a good usability of the compass function of the mobile station is provided.

Whenever the mobile station is located in the same area as a network element 28 of a mobile communication system at which location data is available, the clock application 22 may also receive the location data from the network element 28 via the transceiver 27 of the mobile station 20. This requires, however, that there is a sufficient field strength available at the location of the mobile station 20, while the operation described with reference to FIG. 3 does not require any existing RF field.

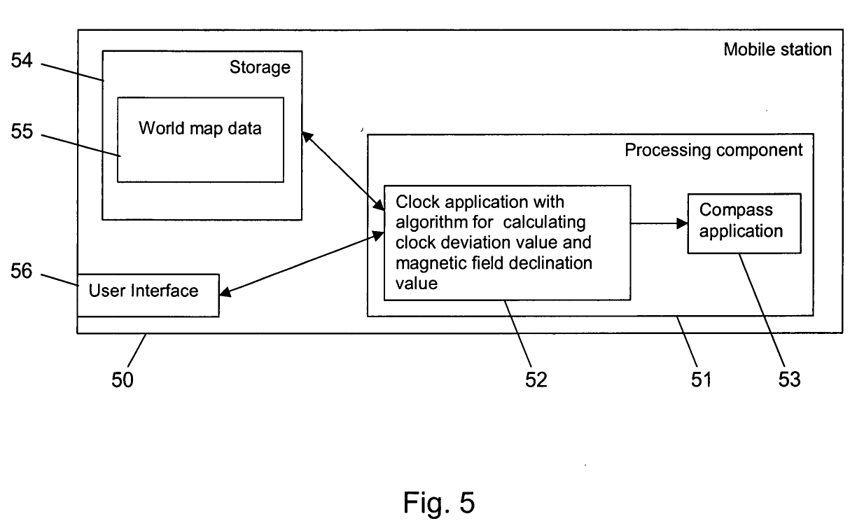

FIG. 5 schematically presents a second mobile station 50 as a second embodiment of a mobile device according to the invention. Also mobile station 50 provides a compass function which can be adjusted to the declination at a respective location.

The mobile station 50 comprises a processing component 51 which may run a clock application 52 providing various clock related functions to a user and a compass application 53 providing a compass function to a user.

The clock application 52 includes in this embodiment a mathematical algorithm for calculating a time adjustment value and a declination correction value for a given location.

The clock application 52 moreover has access to a storage component 54, which stores data 55 enabling a presentation of a map of the world. In addition, the clock application 52 has access to a user interface 56.

It is to be understood that the mobile station 50 can interact again with a network element supporting an adjustment of the compass function of the mobile station in certain situations, even though a transceiver is not depicted in FIG. 5.

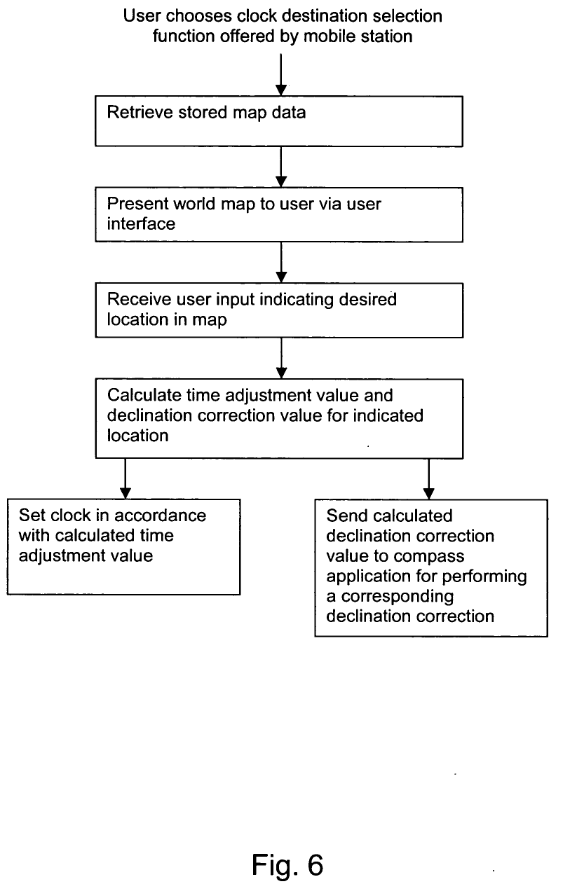

The adjustment of the compass function provided by the compass application 53 of the mobile station 50 of FIG. 5 will now be explained with reference to FIG. 6, which is a flow chart illustrating the operation of the clock application 52 of the mobile station 50 of FIG. 5.

A user who has changed his or her location may choose a clock destination selection function offered by the clock application 52 of the mobile station 50 for updating the clock of the mobile station 50.

Thereupon, the clock application 52 retrieves the stored world map data 55 from the storage component 54.

Based on the retrieved word map data 55, the clock application 52 presents a corresponding map of the world to the user via the user interface 56. The presentation can be similar as the presentation of the map of the world in FIG. 4. The user may point out any desired location on the world map, for instance by means of a cursor. The user may then select a desired, pointed out location by activating a select function, similarly as in FIG. 4. Alternatively, the presentation can be left again by activating a cancel function, similar to that shown in FIG. 4.

In case the user selects a desired location from the presented world map, the clock application 52 receives a corresponding user input from the user interface 56.

Next, the clock application 52 calculates a time adjustment value and a declination correction value for the desired location by means of the comprised mathematical algorithm.

The clock application 52 then sets the clock of the mobile station 50 in accordance with the calculated time adjustment value, as known from the state of the art.

In addition, the clock application 52 sends the calculated declination correction value to the compass application 53. The compass application 53 performs thereupon a declination correction in accordance with the calculated declination correction value. The compass application 53 uses this declination correction until a further update of the clock is caused by the user.

Concerning user friendliness, the second presented embodiment of the invention has the same advantages as the first presented embodiment of the invention.

However, while the first presented embodiment enables a particularly accurate declination correction for all selectable locations, the second presented embodiment allows to select any location on a map, not only those stored in a world clock destination table. Further, less memory space is needed with the second presented embodiment.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A mobile device comprising:
at least one application;
a user interface enabling a user to select a geographical location as input for a further application; and
a processing component adapted to automatically determine for a geographical location selected by a user via said user interface a geographically varying value of at least one parameter;
wherein said at least one application is adapted to use a value of said at least one parameter, determined by said processing component, for adjusting its operation to a geographical location selected by a user via said user interface as input for said further application.

2. A mobile device according to claim 1, wherein said further application is one of an application controlling a clock of said mobile device and a weather service application.

3. A mobile device according to claim 1, further comprising a storage component for storing a plurality of geographical locations and associated to each stored geographical location a value of said at least one parameter, wherein said processing component is adapted to retrieve a list with said stored geographical locations from said storage component, to present said list to a user via said user interface, and to determine a value of said at least one parameter for a geographical location selected by a user from said list presented via said user interface by selecting a value of said at least one parameter associated in said storage component to said selected geographical location.

4. A mobile device according to claim 3, wherein said further application is an application controlling a clock of said mobile device, wherein said storage component further stores associated to each stored geographical location a value for a time adjustment of said clock, wherein said processing component is further adapted to determine a value for said time adjustment for a geographical location selected by a user from said list presented via said user interface by selecting a value for said time adjustment associated in said storage component to said selected geographical location.

5. A mobile device according to claim 1, further comprising a storage component storing data of a map, wherein said processing component is adapted to retrieve said data of said map from said storage component, to present a corresponding map to a user via said user interface, and to determine said value of said at least one parameter value for a geographical location selected by a user via said user interface by means of a mathematical algorithm.

6. A mobile device according to claim 5, wherein said further application is an application controlling a clock of said mobile device, wherein said processing component is further adapted to calculate a value for a time adjustment of said clock for a geographical location selected by a user via said user interface by means of a mathematical algorithm.

7. A mobile device according to claim 1, wherein said at least one application comprises a compass application, and wherein said geographically varying value of at least one parameter comprises a value which is at least related to a declination correction value for said compass application.

8. A mobile device according to claim 1, wherein said at least one application comprises a lightning alerting application, and wherein said geographically varying value of at least one parameter comprises a value which is at least related to at least one of a probability of lightning at a specific geographical location and a desired lightning detector sensitivity setting for a specific location.

9. A mobile device according to claim 1, further comprising a receiving component for receiving information on the current location of said mobile device from a mobile communication network via the air interface, wherein said processing component is further adapted to automatically determine for a geographical location identified by said mobile communication network a geographically varying value of said at least one parameter, if such location information is received from said mobile communication network when an updating of said parameter is required.

10. A software program product in which a software code for supplying at least one application in a mobile device with a geographically varying parameter value is stored, said software code realizing the following steps when running in a processing component of a mobile device:
receiving information on a geographical location selected by a user via a user interface as input for a further application;
determining for said selected geographical location a value for a geographically varying value of at least one parameter; and
providing said determined value of said at least one parameter to said at least one application in order to enable said at least one application to adjust its operation to said selected geographical location.

11. A method of adjusting the operation of at least one application in a mobile device based on a geographically varying parameter value, said method comprising:
receiving information on a geographical location selected by a user via a user interface of said mobile device as input for a further application;
determining for said selected geographical location a geographically varying value of at least one parameter; and
adjusting the operation of said at least one application to said selected geographical location using said determined value of said at least one parameter.

12. A method according to claim 11, wherein said further application is one of an application controlling a clock of said mobile device and a weather service.

13. A method according to claim 11, further comprising presenting a stored list with geographical locations to a user, wherein associated to each stored geographical location a value of said at least one parameter is stored, and wherein determining a value of said at least one parameter for a selected geographical location comprises selecting a stored value of said at least one parameter which is associated to said selected geographical location.

14. A method according to claim 13, wherein said further application is an application controlling a clock of said mobile device, wherein associated to each stored geographical location in addition a value for a time adjustment of said clock is stored, said method further comprising determining a value for a time adjustment by selecting a stored value for said time adjustment which is associated to said selected geographical location.

15. A method according to claim 11, further comprising retrieving stored data of a map and presenting a corresponding map to a user, wherein determining a value of said at least one parameter for a selected geographical location comprises calculating said value by means of a mathematical algorithm.

16. A method according to claim 15, wherein said further application is an application controlling a clock of said mobile device, said method further comprising calculating a value for a time adjustment of said clock for said selected geographical location by means of a mathematical algorithm.

17. A method according to claim 11, wherein said at least one application comprises a compass application, and wherein said geographically varying value of said at least one parameter comprises a value which is at least related to a declination correction value for said compass application.

18. A method according to claim 11, wherein said at least one application comprises a lightning alerting application, and wherein said geographically varying value of at least one parameter comprises a value which is at least related to at least one of a probability of lightning at a specific geographical location and a desired lightning detector sensitivity setting for a specific location.
